(19) United States
(12) Patent Application Publication
(10) Pub. No.: US 2020/0034338 A1
(43) Pub. Date: Jan. 30, 2020

(54) SYSTEM AND METHOD OF VIRTUAL/AUGMENTED/MIXED (VAM) REALITY DATA STORAGE

(71) Applicant: JUJO, INC., A DELAWARE CORPORATION, Boulder, CO (US)

(72) Inventors: Antonio Gentile, Boulder, CO (US); Andrei Khurshudov, Niwot, CO (US); Rafael Gutierrez, Lafayette, CO (US)

(73) Assignee: JUJO, INC., A DELAWARE CORPORATION, Boulder, CO (US)

(21) Appl. No.: 16/583,904

(22) Filed: Sep. 26, 2019

Related U.S. Application Data
(60) Provisional application No. 62/711,386, filed on Jul. 27, 2018.

(51) Int. Cl. G06F 16/174; G06F 16/11; G06F 3/06

(52) U.S. Cl. CPC G06F 16/1748; G06F 16/122; G06F 3/067; G06F 3/0631; G06F 3/0649; G06F 3/0605

(57) ABSTRACT

A method and system of data storage. First and second data sets are received from a data collection system with a plurality of data collection devices that provide data in at least two different data formats. The data is space-time stamped (collection location, and/or orientation) and sensor data is also stamped along with. A content acquisition module with a narration unit template having first and second narration unit associated with each other tills the narration units in sequence via a data associator according to operator instructions. A data recorder that records filled narration units in association with each other according to a predefined association within a federated database.

### CROSS-REFERENCE TO RELATED APPLICATIONS

This invention claims priority, under 35 U.S.C, § 120, to the U.S. Provisional Patent Application No. 62/711,386 to Antonio Gentile, et al., filed on 27 Jul., 2018 which is incorporated by reference herein in its entirety.

### BACKGROUND OF THE INVENTION

### Field of the Invention

The present invention relates to data storage, specifically methods and systems to process data of multiple formats for storage.

### Description of The Related Art

Data collection is the process of gathering and processing information on desired topics, which then may be used by automated and/or manual systems to instruct decisions, educate, control systems, further scientific research, asses quality, and etc. As data is so collected, it must necessarily be stored, even if temporarily, in order to serve an end purpose. Accordingly, data collection systems are generally associated with and/or include data storage systems, with the data collected by the data collection system being fed into the data storage system.

A data collection system (DCS) generally includes a computer application that facilitates the process of data collection. The DCS will collect data according to predefined formats) and/or protocols which then generally become (transforming or not) storage formats for data storage systems. Some data collection systems are very simple (e.g. a user tillable form provided over the web via html) while others are more complicated and may include various data types and formats (e.g. time-registered audio and video data from a video camera and microphone with appended meta-data, e.g. title, author).

Data may be observational, experimental, simulation, reference, and/or derived/compiled and may come in many forms: text, numeric, audio, video, encoded, encrypted, multimedia, etc. When stored, digital data is stored in predefined tile formats in order to provide an orderly way for computing systems to retrieve and provide the stored data. The following are non-limiting examples of file formats:
Text, Documentation, Scripts: XML, PDF/A, HTML, Plain Text.
Still Image: TIFF, PEG 2000, PNG, JPEG/JFIF, DNG (digital negative), BMP,
Geospatial: Shapefile (SHP, DBF, SHX), GeoTIFF, NetCDF.
Graphic Image:
   Raster formats: TIFF, JPEG2000, PNG, JPEG/JFIF, DNG, BMP, GIF.
   Vector formats: Scalable vector graphics, AutoCAD Drawing Interchange Format, Encapsulated Postscripts, Shape files.
   cartographic: Most complete data, GeoTIFF, GeoPDF, GeoJPEG2000, Shapefile,
Audio: WAVE, AIFF, MP3, MXF, FLAC.
Video: MOV, MPEG-4, AVI, MXF.
Database: XML, CSV, TAB.

Some data formats are very large compared to others and some are more difficult to manage/edit/display than others. Accordingly, computing requirements may vary according to what kind(s) of data are being collected and/or stored and to what use that data is being put.

In the related art, it has been known to use data collection and storage systems to collect and store data in ways that are useful to the end purposes of the data collection. Some improvements have been made in the field. Examples of references related to the present invention are described below their own words, and the supporting teachings of each reference are incorporated by reference herein:

U.S. Pat. No.: 7,490,085 issued to Walker et al., discloses a technique for enhancing performance of computer-assisted data operating algorithms in a medical context. Datasets are compiled and accessed, which may include data from a wide range of resources, including controllable and prescribable resources, such as imaging systems. The datasets are analyzed by a human expert or medical professional, and the algorithms are modified based upon feedback from the human expert or professional. Modifications may be made to a wide range of algorithms and based upon a wide range of data, such as available from an integrated knowledge base. Modifications may be made in sub-modules of the algorithms providing enhanced functionality. Modifications may also be made on various bases, including patient-specific changes, population-specific changes, feature-specific changes, and so forth.

U.S. Pat. No.: 8,307,273 issued to Pea et al., discloses electronic methods and apparatus for interactively authoring, sharing and analyzing digital video content. Methods for authoring include displaying visual data, defining each traversal as a time-based sequence of frames and annotating and storing a record of the traversal and its associated audio records. Defining the traversal includes interactively panning the visual data by positioning an overlay window relative to the visual data and zooming in or out by resizing the overlay window. In alternative embodiments, the visual data may be displayed in a rectangular layout or a cylindrical layout. The methods are practiced using an integrated graphical interface, including an overview region displaying the visual data, a detail region displaying current data within the overlay window, and a worksheet region displaying a list of previously stored annotated traversal records. In a further aspect, the worksheet region list of annotated traversal records is published in a web document accessible via network using a standard. HTML browser, and further annotations may be added by a community of network users. Analytical methods are also provided in which data markers corresponding to traversal records are plotted against an interactive abstract map enabling users to shift between levels of abstraction in exploring the video record.

U.S. Pat. No.: 6,438,353, issued to Casey-Cholakis et al., discloses a method of providing training to a plurality of users in a system including a training system and a plurality of user systems coupled to the training system via a network. The method includes receiving a request for training at the training system and providing a training program to the user system in response to the request for training. The method also includes receiving a request to edit or create a training program and providing an editable training program template to the user system in response to the request to edit or create a training program. The editable training program template permits entry of content for the training program. Other embodiments of the invention include a system and storage medium for implementing the method.

U.S. Pat. No: 6,589,055, issued to Osborne et al., discloses system and method for computer aided training and certification employs a central network for storing certification information and a plurality of training units. In preferred embodiments, the training units are individual systems comprising training software running on a turn-key based personal computer. An advantage of the invention is that the software is completely customized on each training unit to provide instruction using customized multi-media content, such as high quality digital video footage, taken of the trainee's specific job tasks and work site, as well as questions and instructional scripts customized for the job tasks and work site.

The inventions heretofore known suffer from a number of disadvantages which include failing to adequately structure data, especially related data of various formats; having access times that are too long; being difficult to edit; being difficult to publish; not allowing for data from multiple devices; having long query times; and requiring high processing power for editing, distribution, publishing, and/or viewing.

What is needed is a system and/or method of data storage that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems anal methods. Accordingly, the present invention has been developed to provide a system and method of data storage.

In one non-limiting embodiment, there is a method of data storage that may operate within a networked computing system. The method may include one or more of the steps of: receiving a narration architecture selection instruction over a computerized network; activating a first narration unit of a selected narration architecture template which may be in response to the received narration architecture selection instruction; receiving a first data set from a data collection system which may include a plurality of data collection devices that may provide collected data in at least two different data formats, such first data set being first received data; automatically space-time stamping the first received data and/or automatically associating the first received data with the first narration unit, thereby generating first filled narration unit; receiving an operator signal from the data collection system and, which may be in automatic response thereto, deactivating the first narration unit and/or activating a second narration unit, the second filled narration unit may automatically having a structural relation to the first filled narration unit which may be as determined by the selected narration architecture template; receiving a second data set, wherein such second data set may be second received data; automatically space-time stamping the second received data and/or automatically associating the second received data with the second narration unit, thereby generating second filled narration unit; automatically generating first searchable data which may be from the first received data and/or second searchable data which may be from the second received data; associating the first searchable data with the first filled narration unit and/or associating the second searchable data with the second filled narration unit; and/or recording the first filled narration unit and/or the second filled narration unit together within a federated database which may be according to the structural relation.

It may also be that the step of automatically space-time stamping the first received data includes associating a time of data collection and/or either a position of data collection or an orientation of data collection with the first received data.

It may also be that the step of automatically generating first searchable data includes scraping text, from non-text data within the first filled narration unit and/or recording the scraped text in a text format.

It may be that the step of automatically space-time stamping the first received data includes associating a received sensor data with the first received data.

The method may also include one or more of the steps of: generating an electronic publication file which may be by executing a query against the federated database, the query may be including terms that relate to searchable data in each of the first and second filled narration units; and/or receiving an edit operator signal and, which may be in automatic response thereto, deactivating the second narration unit and/or re-activating the first narration unit such that additional received data sets are automatically associated with the first narration

In another non-limiting embodiment, there is a system of data storage in communication over a network, which may include one or more of: a data collection system, which may include a plurality of data collection devices that may provide collected data in at least two different data formats; a time-space stamper that may be in communication with the data collection system that automatically stamps data from the data collection system with meta-data pertaining to one or more of data collection time, data collection location, and data collection orientation; a federated database; and/or a content acquisition module in communication with the data collection system, the time-space stamper, and the federated database, including one or more of: a narration unit template with a first and second narration unit having a predefined association with each other; a data associator that associates received data from the data collection system to narration units of the narration unit template according to operator instructions; and/or a data recorder that records filled narration units in association with each other according to the predefined association within the federated database.

The system may also include one or more of: a content authoring module that may edit filled narration units; a narration unit publisher that may automatically generate an electronic publication file from the filled narration units; a sensor data stamper that may stamp data from the data collection system with sensor data from the data collection system; and/or an API service that may be in communication with the federated database that may make queries to the federated database for identifying and/or streaming multimedia data from the filled narration units.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may he learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 illustrates a non-limiting exemplary network topology associated with a system and method of data storage, according to one embodiment of the invention;

FIG. 2 is a flow chart showing a method of storing data, according to one embodiment of the invention;

FIG. 3 is a sequence diagram showing a method of data acquisition for a system and method of data storage, according to one embodiment of the invention;

FIG. 4 is a data model diagram showing data models that may be used with a system and method of data storage, according to one embodiment of the invention;

FIG. 5 is a sequence diagram showing a method of creating a filled narration unit, according to one embodiment of the invention;

FIG. 6 is a syntax diagram for generation of a narration unit via a query, according to one embodiment of the invention; and

FIG. 7 is a sequence diagram showing a method of accessing stored narration unit data, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

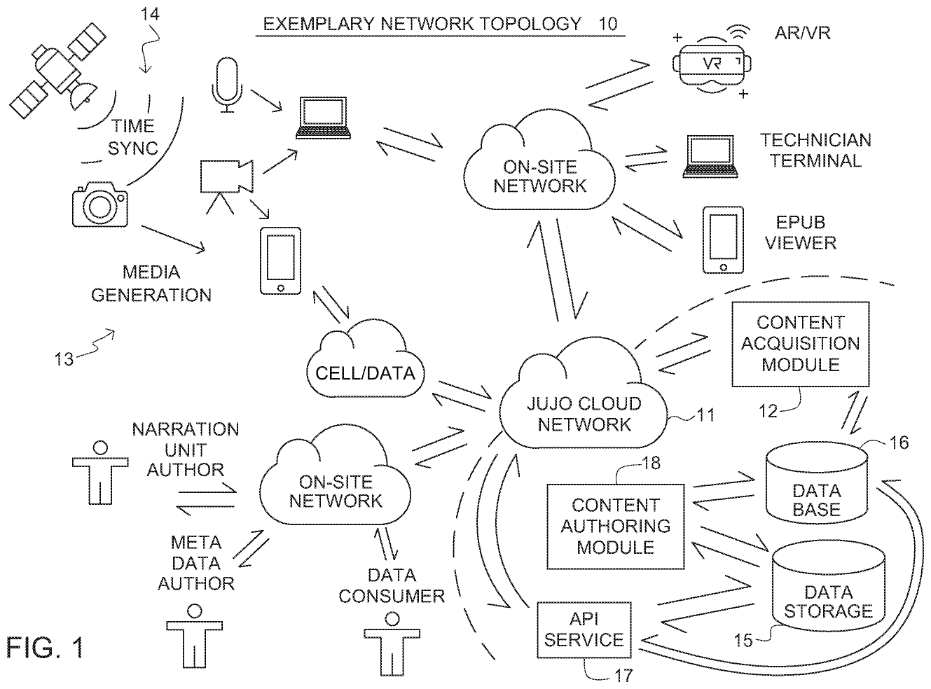

FIG. 1 illustrates a non-limiting exemplary network topology associated with a system and method of data storage, according to one embodiment of the invention. There is shown a computerized network 10 containing devices that generate data, view data, and network appliances for data storage, formatting, and publishing. Advantageously, the illustrated system provides for acquisition, storage, and publication of media of multiple types/formats in a manner that requires less processing power, facilitates rapid query responses from storage devices, and allows for easier and automated content editing/updating.

Looking to the top left of the illustration, there are shown a data collection system for collecting multimedia data, such as but not limited to images, audio, video, measurement, and telemetry data, having a plurality of media generation devices 13 (e.g. camera; video camera; microphone; VR camera; 360 degree video camera; 3D scanners; QR code scanner; and sensors such as but not limited to geophones, hydrophones, seismometers, air flow meters, position sensors, hall effect sensors, speed sensors, pressure sensors, light meters, oxygen sensors, radar devices, torque sensors, chemical sensors/monitors, current sensors, electroscopes, hall probes, magnetometers, metal detectors, voltage detectors, flow sensors, gas meters, Geiger counters, attitude indicators, depth gauges, magnetic compasses, gyroscopes, angle meters, displacement sensors, accelerometers, odometers, proximity sensors, and the like and combinations thereof) which may be in functional communication with local network interfaces (e.g. the illustrated smartphone and laptop) or direct connections to a network (e.g. the internet). The illustrated data collection devices provide collected data in a plurality of different data formats (e.g. various file formats such as but not limited to WAV, AVI, text, numeric, encoded).

The illustrated data collection devices include timers that are in communication with a time synch 14 system (e.g. GPS receiver, Network Time Server) such that the data collected is automatically time stamped with the time of creation (e.g. start/stop times). Alternatively, time-stamping may occur via the local network interface and may be provided alongside the data and/or appended thereto. The media generation and/or local network interfaces may include position and/or orientation sensors that may collect special information related to the collected data and such may also be provided alongside the data and/or appended thereto (as metadata). Accordingly, wherein the data in associated with temporal and/or spatial information collected contemporaneously with the data, that data is therefore time-space stamped. Additionally, other kinds of data may be stamped to the media such as but not limited to wherein a sensor data stamper that stamps multimedia data from the data collection system with sensor data (e.g. temperature, pressure, flow rate) from the data collection system. The sensor data that is stamped will generally be data that is contemporaneous with the multimedia data that was collected. Such data may be stamped together with time-space stamping (e.g. video data of an interior of a furnace that is temperature stamped with the internal temperatures of the furnace together with the exit temperature of a fluid outlet line exiting the furnace and a location stamp that identifies which furnace unit is being recorded and an orientation stamp that identifies through which port the video is being taken).

The illustrated local network interfaces are in communication with networks (e.g. the illustrated smartphone is connected to a cellular or data network and the illustrated laptop is connected to an on-site network such as but not limited to a corporate intranet. Accordingly the generated multimedia data is provided to the network. The local network interfaces (and/or the data generation devices themselves) may include a client application that coordinates data collection and time-space stamping. Such a client application may also provide controls for a user to selectably provide operator signals, such as those described herein to activate/deactivate narration units.

The illustrated network(s) include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference. A non-limiting example of a network card may be a Belkin Gigabit Ethernet Express Card, manufactured by Belkin International Inc., 12045 E. Waterfront Dr., Playa Vista, Calif., 90094.

Looking to the upper right portion of the illustration, there is shown a plurality of viewing devices in communication with an on-site network. There is shown an AR/VR headset, a laptop used as a terminal (e,g. for a technician), and an ePub viewer for viewing e-books. The illustrated viewing devices allow users to experience multimedia data such as but not limited to the raw data provided by the media generation devices, or authored data that may be stored in a data storage system. Accordingly, users may experience such data for quality control, editing, and the like and also for utilizing the data, such as but not limited to experiencing the data as education, a game, training, on-site guidance for work/repairs/maintenance., and the like and combinations thereof. Such may be of particular use in manufacturing and service industries, such as energy, aviation, building, construction, automotive, and the like where experts may collect time-space stamped multimedia data associated with proper care/maintenance of on-site equipment/machinery in multiple formats which may then be authored into VAM (Virtual/Augmented/Mixed) Reality tools for less experienced professionals to use on or off site when performing similar functions.

Looking to the lower left portion of the illustration, there are a plurality of actors in communication with the network (e.g. via the illustrated on-site network) via user interface devices having network access (e,g. smartphones, tablets, laptops, personal computers, dumb terminals, servers). The illustrated Meta Data Authors make requests via API Service to publish meta data related to Data Records generated by Data Generation Devices. The illustrated Narration Unit Authors make requests via API

Service to trigger the Authoring Module (e.g. to generate/edit Narration Units). The illustrated Data Consumers make requests via API Service to retrieve and view structured multimedia data (e.g. Timeline and Narration Unit ePubs).

Looking to the lower right portion of the illustration, there is a Cloud Network 11 in communication with the on-site network and the cell/data network and also in communication with the content acquisition module 12 and the API service 17. The illustrated content acquisition module 12 is in further communication with the illustrated database 16 and the illustrated API service 17 is in further communication with the database 16 and the data storage 15. Each of the illustrated database 16 and data storage 15 are in communication with the content authoring module 18. The illustrated cloud network is entitled Jujo Cloud Network herein to distinguish it from the on-site network, whereas in one non-limiting embodiment, a service provider, e.g. Jujo, provides system components illustrated in the lower right portion of the illustration to an organization that has an existing intranet, the on-site network. Accordingly, high level data storage services may be provided to organizations that do have some computerized infrastructure but do not have the computer infrastructure necessary to implement the illustrated system. There may be further functional communication, which may be direct communication, between one or more illustrated elements that is not illustrated that one of ordinary skill in the art would recognize as being necessary or useful for the operation thereof and/or for operation of method steps described herein, including optional/alternative steps. Further, illustrated elements that share communication with intermediate elements are considered to be in communication with each other.

The illustrated content acquisition module may include a narration unit template, a data associator, a data scraper, and/or a data recorder. The content acquisition module includes a network interface (e.g. network adaptor, cellular adaptor) though which is receives data from the media generation devices. The network interface feeds into a data processing application that includes instructions for associating files herein the data associator and a scripted application that generates data records according to associations between files and feeds that, through the network interface to the database in a format receivable by the database.

The narration unit template may be included within a library of narration unit templates. The library may be accessible, via the illustrated network, to the media generation devices and/or the narration unit author, whereby a particular narration unit template may be selected in preparation to data collection. A narration unit may include one or more narration units having predefined characteristics, including but not limited to: associations with other narration units, allowable file types/formats, required file types/formats, allowable/required metadata/annotations, allowable/required time-space-sensor stamping, operator scripting for switching between related narration units, and the like and combinations thereof. Individual narration units within a template may be associated with each other sequentially, alternatively, and/or concurrently. As a non-limiting example, there may be a narration unit template with a plurality of narration units associated in various ways, including but not limited to:

single sequential streams

A→B→C→D

alternative selections along a single stream

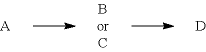

branching/looping alternatives

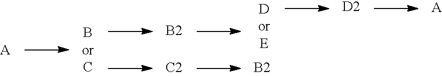

Such templates may also include scripting for a predefined order of “filling” which may be as simple as a sequential order to the filling, filling the next narrational unit on each operator signal, or may be triggered by position, location, sensor data, or the like. Operator signals issued during data collection (e.g. via a timed script, the actor saying “Jujo switch” into a microphone coupled to a voice recognition system scripted to issue an operator signal, the actor pressing a programmed button on a media generation device, a recorded temperature exceeding a predefined threshold) allow for automated “filling” of associated narration units with multimedia data together with structuring of that associated data in a manner that facilitates easy/fast/low resource manipulation, editing, querying, quality control processing, and publishing.

The data associator that associates received data from the data collection system to narration units of the narration unit template according to operator instructions. The data associator may be resident within one or more applications coupled to the media generation devices (e.g. an application running on a smartphone that is being used to record audio/video) and/or it may be resident on a server coupled to the Jujo cloud network. Data associators are present in generally all database applications here records are formed. The data associator may include one or more scripts that edit/annotate data objects and/or append metadata thereto, thereby forming records having data fields that include associated data. The data associator may check the data for required metadata/formats/etc. where narration units are required to have particular data and may return data requests to the media generation device(s) where required information is missing. The data associator may receive data according to a protocol and store that data in data records according to the protocol. In one non-limiting example, data is received and stored in a record according to the following protocol: (fields in order of arrival, each line a record):

date1, time1, location, keyword 1 . . . keywordN, subject1 . . . subject, DATA1

date1, A time2, location., keyword 1 . . . keywordN, subject1 . . . subject, DATA2 Records that are formed by the data associator are then associated with an active narration unit, thus “filling” the narration unit. When the active narration unit is deactivated and another narration unit is activated, the next narration unit then receives and is associated with data records that are next generated, so long as that narration unit is active.

The data scraper scrapes non-searchable data from the multimedia data and generates searchable data therefrom. Such may include one or more pattern recognition systems such as but not limited to Computer-Aided Diagnostic Systems, facial recognition, shape recognition systems, OCR systems (Optical Character Recognition e.g. Amazon Textract by Amazon, OCR Solutions for Business by Concord) that scrapes images/video, generating text data that is visible therefrom, and voice recognition systems that scrape audio data for text recognizable therein. The data scraper provides th searchable scraped data to the data recorder to record in association with the media files, so that the scraped data is searchable. As a non-limiting example, an engineer may be recording (audio and video registered temporally) a repair of a valve assembly and may mention a particular tool while narrating the repair. The audio narration may be scraped and provided as text such that a query using the name of the tool mentioned could be used to retrieve the associated audio/video recording.

The data recorder saves the associated data to the database according to the associations defined by the data associator. It may be that the data recorder records filled narration units in association with each other according to the predefined association within a federated database. As a non-limiting example, the data recorder may store data into an XML “content document,” NoSQL database, or some other appropriate storage application.

The illustrated content authoring module allows for an actor to author content utilizing the data stored in the database and/or data storage. Such may be in the form of an electronic publication, generally a multimedia electronic book and/or VAM media publication, wherein narration units may be queried and associated/annotated/edited to generate the same. The content authoring module may edit filled narration units and/or may automatically generate an electronic publication file from the filled narration units. Authored content may be vetted by a content vetting module, which allows for production titles to be vetted and validated against a workflow by skilled supervisors, so ensure applicability and absence of defects. Blockchain certification may be used to provide attribution control, based on a permissioned ledger system. The vetted workflow title can be generated, stored, and distributed in a multimedia (MM) ePub format or other suitable format (e.g. VAM) for fuition on AR/VR or mobile devices. The same filled narration unit may be utilized for multiple workflow titles,

The illustrated API Service. The API service may be in communication with a federated database and may make queries to the federated database for identifying and/or streaming multimedia data from the filled narration units, which may be in the form of an electronic publication, generally a multimedia electronic book and/or VAM media publication.

The illustrated database is an organized collection of data stored within a computer system, which may include raw data. The database may be relational, flat file, hierarchical, object-oriented, network-model, and/or federated. The following are non-limiting examples of databases that may be utilized within the illustrated network: XML, NoSQL, NewsSQL, OQL, and. SQL.

The illustrated data storage may include a relational database, a federated database and/or raw storage. The data storage system collects and store data for one or more of the modules/elements of the system, as appropriate to the functions thereof. The data storage system is in communication with the various modules and components of the system over a computerized network and stores data transferred there through. The data storage system stores data transferred through each of the modules of the system, thereby updating the system with up to date data. The data storage system securely stores user data along with data transferred through the system. Data storage systems may include databases and/or data files. There may be one or more hardware memory storage devices, which may be, but are not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

In operation of one non-limiting embodiment, new data enters to JuJo Cloud, sent to the Content Acquisition Module. There it is annotated and written to the Database. Triggered (e,g. by either time or a user), the Content Authoring Module requests Data Records from the Database, generates an ePub, and pushes it, to Data. Storage. The API Service makes queries to the Database for identifying and streams data from Data Storage.

In one non-limiting embodiment, there is a collection of data collection devices, such as but not limited microphones, cameras, position-tracking, 3D scanners, depth cameras, GPS devices, and orientation s that are in functional communication with a data storage system. As the data is collected, it is automatically separated into sets of narration units, which are associated with each other into a workflow structure. As such, the data may then be transformed within the system into useful multimedia packages for distribution and delivery to match with operational requirements for the same.

During collection, the data is time-stamped and/or position/orientation stamped (could be other sensor information, e.g. temperature stamped) and associated with a particular narration unit. Narration units are separated from each other by operators (e.g. button press, scan of QR code, voice recognition of someone saying “Step 1”) that indicate when one narration unit is completed and another begins.

Narration units have a predefined relationship with each other (e.g, sequential, alternative, tree). It may be that narration units are reopened and new material added to that narration unit when certain operators are applied. Audio and text material within a narration unit are automatically converted to searchable data that is associated with the narration unit so that the narration unit can be found via query. The system includes a plurality of workflow structures and a particular workflow structure is selected as the process begins.

That workflow structure then defines the relationship among the narration units as they are collected. There may be a navigational map displayed on a display device and/or indicated by audio or etc. that automatically tracks which narration unit is active and how that relates to the other narration units. The data is stored by a federated database in order to keep attributes among all the files and records associated with a single narration unit. This also allows for enhanced searching and better response time for searches. This also allows for those same records and files to be distributed to the devices that play them without requiring transformation or conditioning of those files.

According to one embodiment of the invention there is a method and system of data storage. First and second data sets are received from a data collection system with a plurality of data collection devices that provide data in at least two different data formats. The data is space-time stamped (collection time, location, and/or orientation) and sensor data is also stamped along with. A content acquisition module with a narration unit template having first and second narration unit associated with each other fills the narration units in sequence via a data associator according to operator instructions. A data recorder that records filled narration units in association with each other according to a predefined association within a federated database.

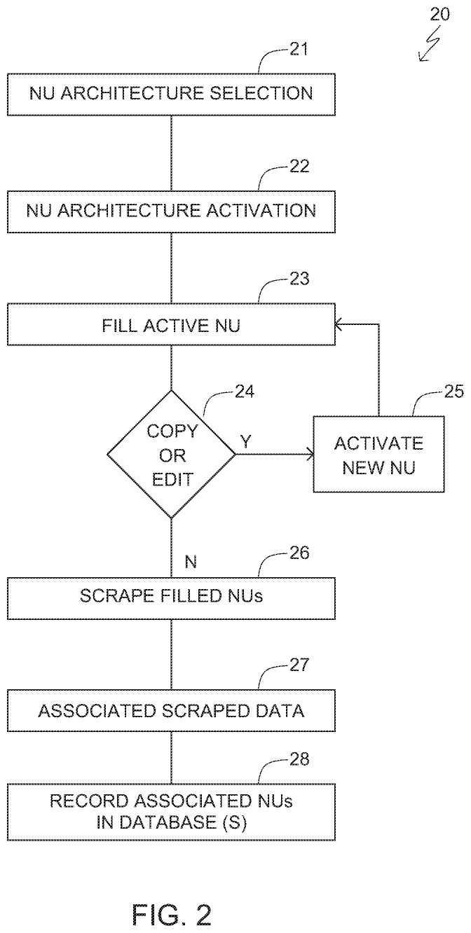

FIG. 2 is a flow chart showing a method of storing data 20, according to one embodiment of the invention. In the illustrated method a narration unit (NU) architecture is selected 21 and then activated 22. The active NU is then “filled” 23 with incoming data from media generation devices until an operator signal 24 triggers either an end to collection or the activation of a new/previous NU. Where a new NU is activated, that NU begins filling 23 with the incoming data stream. Where the signal 24 triggers an end to data collection (at least for any particular NU) the system scrapes the filled and finished NUs for searchable data. The scrapped data is associated with the NU from which it is derived and then a record is created for each NU in one or more databases, which may be part of a federated database.

The step of NU architecture selection 21 may include providing a selection interface over a graphical user interface and receiving a selection therefrom over the computerized network. The selection interface may provide graphical representations of NU architecture and/or descriptions, titles, and the like. In another embodiment, the step of NU architecture selection may be automated, such as but not limited to selecting and/or narrowing down a selection to a smaller subset of selectable architectures based on a login, device activation, location data, time data, or the like and combinations thereof. It may be that a particular user is tasked with generating a particular kind of content, for which a single NU architecture is appropriate and therefore on login the NU architecture is automatically selected by the system and provided over the computerized network.

The step of activation 22 includes automatically activating a particular NU within the selected NU architecture which may be in response to the received narration architecture selection instruction. Such may be triggered automatically according to the pre-defined architecture (e.g. NU 1 of Nus 1-12 is automatically activated first unless other instructions are provided). Such may be triggered by instructions and/or data provided over a user interface from an actor (e,g. data is first collected via video camera on a smartphone and the first NU that is allowed to receive video data within the selected architecture is NU 3 and therefore NU 3 is automatically activated). The activated NU is automatically associated with incoming multimedia data while non-active NUs are not. While a plurality of NUs may be active at the same time, it is contemplated that, for most use instances, a single NU will be active at any given time.

The step of filling an active NU 23 may include receiving one or more data sets from a data collection system which may include a plurality of data collection devices (aka media generation devices). The data collection devices may provide collected data in a plurality of different data formats. Data may be received asynchronously such that a first data set is received and then a second data set and then a third, etc. As the data is received it may be automatically associated with the active NU and may be automatically space-time-sensor stamped (which may have originally occurred at the data collection device). As the data is stamped and associated, the NU is thereby “filled” As NUs are sequentially filled, they become the first, second, third, etc. filled narration units and they retain their association(s) with each other.

Space-time-sensor stamping of the received data may include associating one or more units of contemporaneous information with the received data. The units of contemporaneous data may include time (e.g. start/stop time, duration, date), location (e.g. GPS location, distance from a known location, position on a rail), orientation (e.g. viewing angle/direction, angular position), sensor/telemetry data (e.g. temperature, pressure, speed, flow rate).

The step of signaling a shift in the active NU 24 includes receiving an operator signal, which may be from the data collection system. The signal may be a simple “change” signal that triggers a single kind of change (e.g. deactivate the current NU and activate the next NU in sequence or end if there are no further NU in sequence) or it may be more complicated (e.g. deactivate the current NU and re-activate a previous NU for further filling, or keep the current NU active and activate another NU to be filled simultaneously with the same received data). The operator signal may be triggered by time/sensor data and/or may be triggered by user input (e.g. voice recognition at the data collection device recognizing the phrase “Juju, new unit,” pressing a Next button).

The step of activating a new NU 25 may include deactivating a first/current narration unit(s) and/or activating a second/next narration units. The second narration unit may automatically having a structural relation to the first narration unit which may be as determined by the selected narration architecture template. Once activated, the now active narration unit receives a second/next data set(s), wherein such second data set s generally second/next received data. That next data is also, generally, automatically space-time-sensor stamped and automatically associated with the second/next narration units, thereby generating second/next filled narration unit(s).

The step of scraping filled NU(s) 26 includes activating pattern recognition software/hardware (e.g. OCR, speech recognition, facial recognition, heat map analysis software;) against the received data to automatically generate searchable data from the received data. Searchable data is generally in a text/numerical format, but may be in other formats wherein it is responsive to queries.

The step of associating scraped data 27 associates the searchable data with the received data and/or the NU in a manner that when the searchable data is found via query, the associated received data/NU may be retrieved therewith.

The step of recording associated NU(s) into a database 28 includes recording the first filled narration unit and/or the second filled narration unit together within a data base that may be a federated database. The recording of the NUs together within the database may be according to the structural relation therebetween.

After the record(s) are associated into a database 28, a step of generating an electronic publication file may be executed. Such may be accomplished by executing a query against the federated database, the query may be including teres that relate o searchable data in each of the first and second tilled narration units.

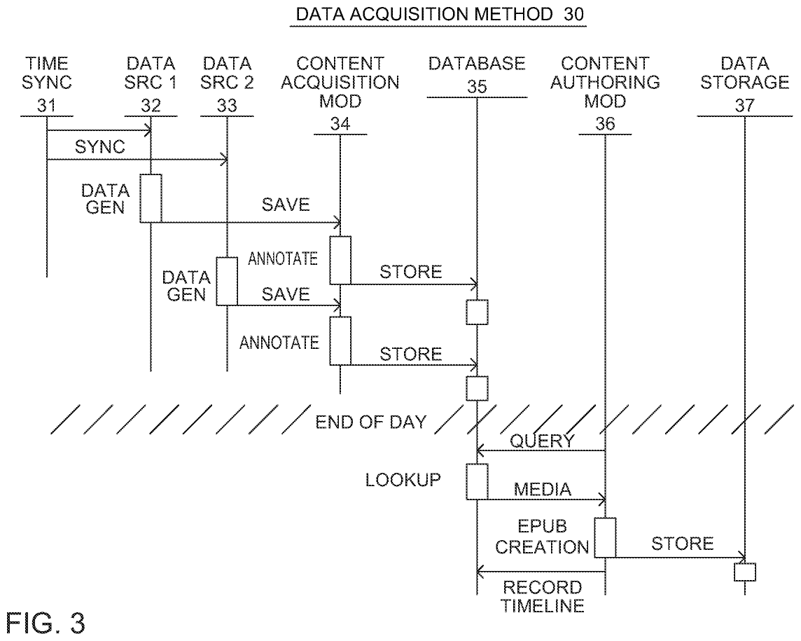

FIG. 3 is a sequence diagram showing a method of data acquisition 30 for a system and method of data storage, according to one embodiment of the invention. The illustrated sequence describes a method to generate and store data used in an MM ePub. It is assumed that at the end of the data the Content Authoring Module will, generally, automatically trigger a query to create the ePub.

The illustrated components of the sequence diagram include:
Time Sync 31: A device that publishes the time sync on all data generation devices,
This action is typically performed by OPS location synchronization or using a network Time Server.
Data Src 1 and 2 (=and 33): Field devices that generate the multi-media data.
Content Acquisition Module 34: The network appliance that allocates data from Data Src and writes to data storage.
Database 35: Relational/NoSQL database used to store metadata of the content genera ted.
Content Authoring Module 36: Then network appliance that converts data into MM ePub,
Data. Storage 37: Location where ePubs are stored after generation.

In operation, the time synch 31 syncs time with the data sources 32 and 33. The two devices generate data based on their given operation. The data generated is published to Content Acquisition Module via Save( ), Annotation converts raw data in to record stored in Database and adds time stamp, keywords, subjects to raw data, published via Store( ). A Lookup is triggered via Query( ) which queries all DataRecords based on DataRecord.start and DataRecord.end and outputs a stream of data/meta data via Media( ). ePub Creation, triggered by Media( ) converts a stream of raw data to MM ePub, wherein the ePub is pushed to Data Storage via Store( ). On Success a record is created to identify ePub via RecordTimeline( ) and the Content Authoring Module Creates TimelineRecord.

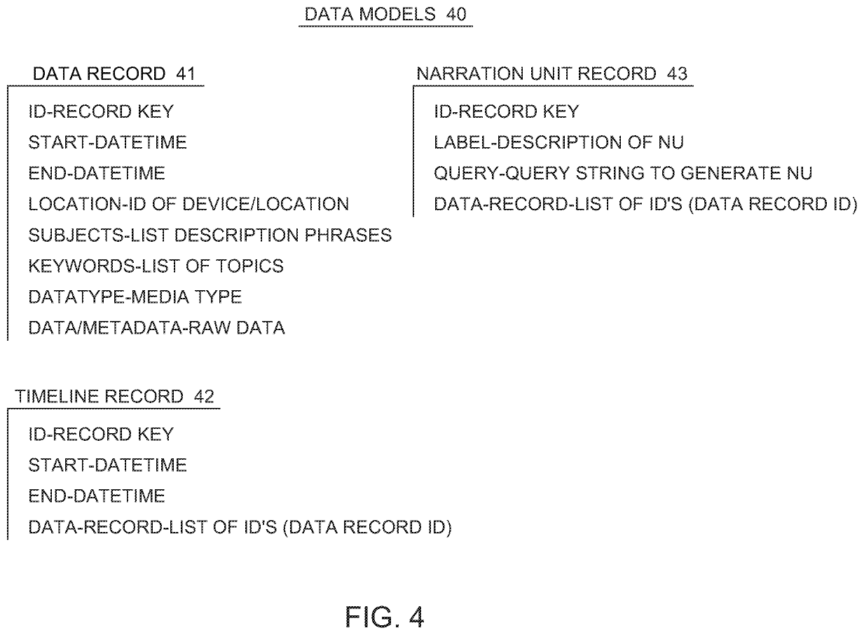

FIG. 4 is a data model diagram showing data models 40 that may be used with a system and method of data storage, according to one embodiment of the invention. The illustrated data models show a description of a non-limiting exemplary data module in a relational database.

The DataRecord 41 type describes the data recorded by Data Source devices, and metadata generated by Users on PCs, Tablets, and Smart Phones.
id: Identifier of the data record.
start end: Start and End times of when the data was created.
location: Identifies the device that created the data/metadata. Could be anything that identifies the source of data.
Serial Number: S/N 12345
Navigational Address: Well Pad/Extraction/Compressor/Heat Exchanger/Temperature
subjects: A list of phrases or a description of the data being recorded
“Temperature of Heat Exchanger in Gas Compression Unit”
keywords: A list of searchable terms related to data being recorded
“well pad, compressor, temperature, measurement”
datatype: An identifier of the data type medium (e.g MIMETYPE)
data/metadata: Raw contents of the data
This could also be stored in file storage as raw data is not always kept Relational Databases.

The TimelineRecord 42 type describes a given timeline and data associated to that period.
id: Identifier of the data record.
start/end: Start and End times covering all data included in the timeline.
data_record: A list of DataRecord.id for all data generated during a time period

The NarationUnitRecord 43 type describes a User generated Narration Unit composing multiple DataRecords into a cohesive story.
id: Identifier of the data record.
label: A descriptive phrase of the contents of the Narration Unit

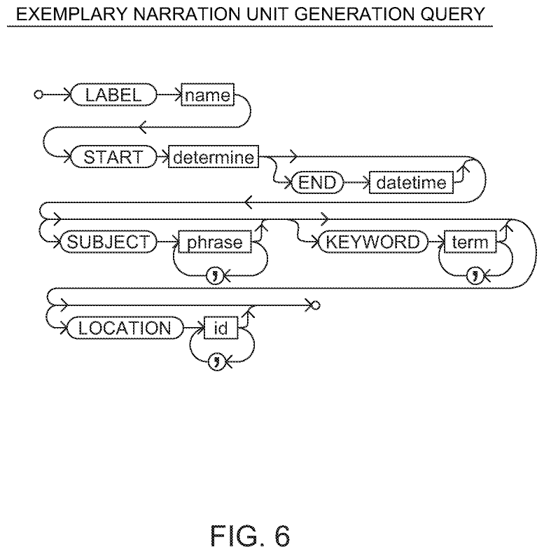

“Detecting a plunger failure in a Plunger Lift Gas Extraction Well”
query: The query string used to generate the list of DataRecords composing this Narration Unit,
See FIG. 6
data_record: A list of DataRecord.id for all data generated related to this

Narration Unit.

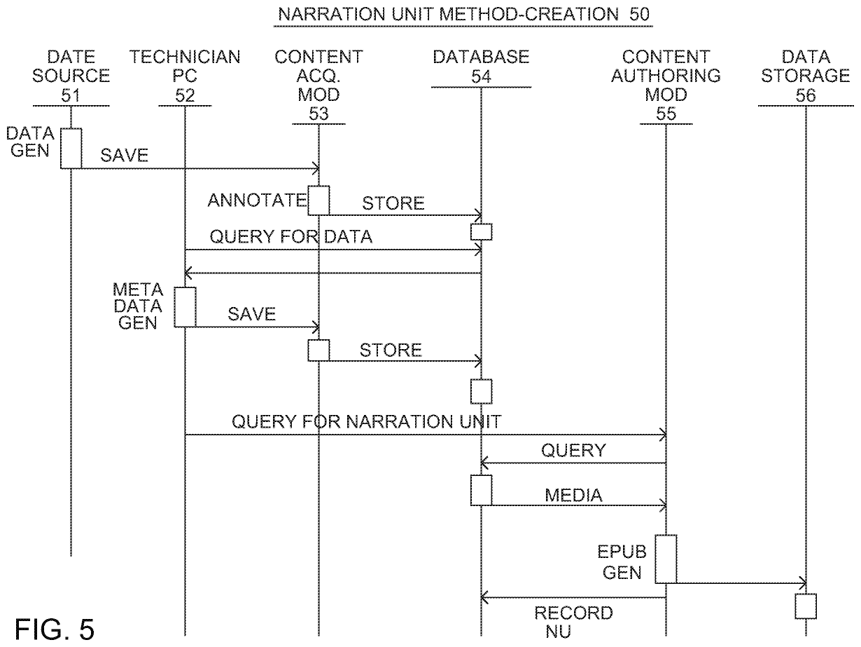

FIG. 5 is a sequence diagram showing a method of creating a filled narration unit 50, according to one embodiment of the invention. The illustration describes a method to create a Narration Unit. The illustrated method assumes that data is generated described in FIG. 3.

The illustrated components of the sequence diagram include:
Data Source 51: Field devices that generate the multi-media data.
Technician PC 52: Computer/Tablet/Interface to create metadata.
Content Acquisition Module 53: The network appliance that allocates data from Data Src and writes to data storage.
Database 54: Relational/NoSQL database used to store metadata of the content generated.
Content Authoring Module 55: Then network appliance that converts data into MM ePub.
Data Storage 56: Location there ePubs are stored after generation.

In operation, a device will generate data based on its given operation and the data generated will be published to Content Acquisition Module via Save( ). Annotation converts raw data in to record stored in Database and adds time stamp, keywords, subjects to raw data, published via Store( ). A QueryforData( )is used by an actor/technician to search for data, wherein identified data to annotate metadata is driven by the technician and the query returns a list of data based on query. On the technician PC, a Meta Data Generation application allows the technician to create meta data based on device created data. As a non-limiting example, such may include notes narrating what is occurring during data and/or a recording of audio to play while viewing data. Output from the technician PC is saved to DB as data via Save( ). Annotation converts raw data in to record stored in Database and adds time stamp, keywords, subjects to raw data, published via Store( ). The Technician PC then executes a QueryForNarrationUnit( ), which is a query to generate a Narration Unit (See FIG. 6 for non-limiting exemplary syntax). The content authoring module 55 executes the query to identify all DataRecords matching query and this outputs a stream of data / meta data via Media( ) The content authoring module 55, triggered by Media( ) converts a stream of raw data to a MM ePub and the ePub is pushed to Data Storage via Store( ) On Success a record is created to identify ePub via RecordNU( ), which creates NarrationUnitRecord.

FIG. 6 is a syntax diagram for generation of a narration unit via a query, according to one embodiment of the invention. This diagram describes a non-limiting exemplary method/model for generating Narration Units. Within this figure: all square items containing capitalized letters are keywords and all round items containing lower case letters are field values.

The query language allows for generating a Narration Unit with:
LABEL: Name of the Narration Unit
START: Start Time of when all data should have been created
END: Optional End Time of when data should have been finished being created
SUBJECT: Zero or more subject phrases a DataRecord.subjects should contain.
KEYWORD: Zero or more keyword terms a DataRecord.keywords should contain.
LOCATION: Zero or more location identifiers a DataRecord.location should contain.

Non-limiting example queries formed via this model/method:

A. A query for all data generated between 2019-01-01 10:35 and 11:00, with terms “plunger” and “failure” as keywords.

LABEL “Detecting a plunger failure in a Plunger Lift Gas Extraction Well”

START 2019-01-01T10:35:00

END 2019-01-01T11:00:00

KEYWORDS “plunger”, “failure”

B. A query that would generate a Narration Unit similar to a TimelineRecord

LABEL “Narration Unit for 2019-01-01”

START 2019-01-01T00:00:00

END 2019-01-01T23:59:59

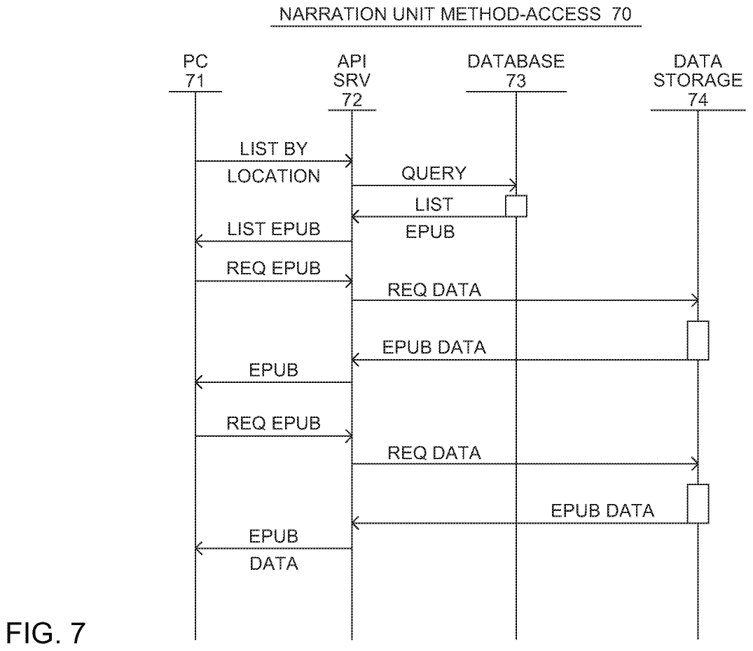

FIG. 7 is a sequence diagram showing a method of accessing stored narration unit data 70, according to one embodiment of the invention. This diagram describes a method to access a Narration Unit MM ePub. It assumed that a Narration Unit ePub was created as described in FIG. 5.

This sequence diagram includes the following components:
PC 71: Computer/Tablet/AR/VR Interface to access MM ePub
All Server 72: Web service providing public or local RESTful/SOAP API
Database 73: Relational/NoSQL database used to store metadata of the content generated,
Data Storage 74: Location where ePubs are stored after generation.

In operation, a ListByLocation( )query is made to API Server 72 for all NU of a given location, wherein the API Server 72 makes query to Database 73 for list of NU matching location via Query( ). That Query( )returns list of ePub available. A RequestePub( )query made to API Server 172 or a specific ePub document, wherein the API Server 72 queries Data Storage 74 via ReqData( )and Data Storage 74 streams ePub content to API Server 72, proxying data back to User. Multiple RequestePub( )can be made to retrieve additional content.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent, to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of data storage within a computing system, comprising the steps of:
a. activating a first narration unit;
b. receiving a first data set, such first data set being s received data, wherein the first data set includes separate data portions including a plurality of different data formats;
c. automatically space-time stamping the first received data and automatically associating the first received data with the first narration unit, thereby generating first filled narration unit;
d. receiving an operator signal and in automatic response thereto deactivating the first narration unit and activating a second narration unit, the second filled narration unit automatically having a structural relation to the first filled narration unit;
e. receiving a second data set, such second data set being second received data;
f. automatically space-time stamping the second received data and automatically associating the second received data with the second narration unit, thereby generating second filled narration unit;
g. automatically generating first searchable data from the first received data and second searchable data from the second received data;
h. associating the first searchable data with the first filled narration unit and associating the second searchable data with the second filled narration unit; and
i. recording the first filled narration unit and the second filled narration unit together within a federated database according to the structural relation.

2. The method of claim 1, wherein the step of automatically space-time stamping the first received data includes associating a time of data collection and either a position of data collection or an orientation of data collection with the first received data.

3. The method of claim 1, further comprising the step of providing a narration unit architecture template including a plurality of pre-associated narration units.

4. The method of claim 1, wherein the step of automatically generating first searchable data includes scraping text from non-text data within the first filled narration unit and recording the scraped text in a text format.

5. The method of claim 1, further comprises the step of providing an operator signal through a data collection device on selection of a user operating the data collection device.

6. The method of claim 1, wherein the step of automatically space-time stamping the first received data includes associating a received sensor data with the first received data.

7. The method of claim 1, further comprising the step of receiving an edit operator signal and in automatic response thereto deactivating the second narration unit and re-activating the first narration unit such that additional received data sets are automatically associated with the first narration unit.

8. The method of claim 1, further comprising the step of generating an electronic publication file by executing a query against the federated database, the query including terms that relate to searchable data in each of the first and second filled narration units.

9. A method of data storage within a networked computing system, comprising the steps of:
a receiving a narration architecture selection instruction over a computerized network;
b. activating a first narration unit of a selected narration architecture template in response to the received narration architecture selection instruction;
c. receiving a first data set from a data collection system including a plurality of data collection devices that provide collected data in at least two different data formats, such first data set being first received data;
d. automatically space-time stamping the first received data and automatically associating the first received data with the first narration unit, thereby generating first filled narration unit;
e. receiving an operator signal from the data collection system and in automatic response thereto deactivating the first narration unit and activating a second narration unit, the second filled narration unit automatically having a structural relation to the first filled narration unit as determined by the selected narration architecture template;
f. receiving a second data set, such second data set being second received data;
g. automatically space-time stamping the second received data and automatically associating the second received data with the second narration unit, thereby generating second filled narration unit;
h. automatically generating first searchable data from the first received data and second searchable data from the second received data;
i. associating the first searchable data with the first filled narration unit and associating the second searchable data with the second filled narration unit; and
recording the first filled narration unit and the second filled narration unit together within a federated database according to the structural relation.

10. The method of claim 9, wherein the step of automatically space-time stamping the first received data includes associating a time of data collection and either a position of data collection or an orientation of data collection with the first received data.

11. The method of claim 10, wherein the step of automatically generating first searchable data includes scraping text from non-text data within the first filled narration unit and recording the scraped text in a text format.

12. The method of claim 11, further comprising the step of generating an electronic publication file by executing a query against the federated database, the query including terms that relate to searchable data in each of the first and second filled narration units.

13. The method of claim 12, further comprising the step of receiving an edit operator signal and in automatic response thereto deactivating the second narration unit and re-activating the first narration unit such that additional received data sets are automatically associated with the first narration unit.

14. The method of claim 13, wherein the step of automatically space-time stamping the first received data includes associating a received sensor data with the first received data.

15. A system of data storage in communication over a network, comprising:
a. a data collection system, including a plurality of data collection devices that provide collected data in at least two different data formats;
b. a time-space stamper in communication with the data collection system that automatically stamps data from the data collection system with meta-data pertaining to one or more of data collection time, data collection location, and data collection orientation;
c. a federated database; and
d. a content acquisition module in communication with the data collection system, the time-space stamper, and the federated database, including:
i. a narration unit template with a first and second narration unit having a predefined association with each other;
ii. a data associate that associates received data from the data collection system to narration units of the narration unit template according to operator instructions; and
iii. a data recorder that records filled narration units in association with each other according to the predefined association within the federated database.

16. The system of claim 15, further comprising a content authoring module that edits filled narration units.

17. The system of claim 15, further comprising a narration unit publisher that automatically generates an electronic publication file from the filled narration units.

18. The system of claim 15, further comprising a sensor data stamper that stamps data from the data collection system with sensor data from the data collection system.

19. The system of claim 15, further comprising an API service in communication with the federated database that makes queries to the federated database for identifying and streaming multimedia data from the filled narration units.

20. The system of claim 16, further comprising:
a. a narration unit publisher that automatically generates an electronic publication file from the filled narration units; and
b. an API service in communication with the federated database that makes queries to the federated database for identifying and streaming multimedia data from the filled narration units.
